(19) United States
(12) Patent Application Publication
(10) Pub. No.: US 2024/0032534 A1
(43) Pub. Date: Feb. 1, 2024

(54) POLYMER ENHANCED HYDROALCOHOLIC DISINFECTING COMPOSITION

(71) Applicant: GOJO Industries, Inc., Akron, OH (US)

(72) Inventor: Matthew E. Secrest, Akron, OH (US)

(21) Appl. No.: 18/355,650

(22) Filed: Jul. 20, 2023

Related U.S. Application Data
(60) Provisional application No. 63/393,272, filed on Jul. 29, 2022.

(51) Int. Cl. A01N 31/02; A01N 25/24; A01N 25/30; A01N 25/34

(52) U.S. Cl. CPC A01N 31/02; A01N 25/24; A01N 25/30; A01N 25/34

(57) ABSTRACT

Hydroalcoholic disinfecting compositions that achieve an enhanced efficacy against harmful microorganisms, including pathogenic microorganisms, are provided. The hydroalcoholic disinfecting compositions contain from 30 to 60 wt. % of one or more C₁-C₁₀ alcohols together with a polymeric enhancer. The hydroalcoholic disinfecting compositions have a pH of less than 3.

### CROSS-REFERENCE TO RELATED APPLICATION(S)

This application claims priority to and any benefit of U.S. Provisional Application No. 63/393,272, filed Jul. 29, 2022, the content of which is incorporated herein by reference in its entirety.

### FIELD

The present disclosure relates to hydroalcoholic compositions for the disinfection of surfaces. More particularly, the present disclosure relates to hydroalcoholic disinfecting compositions containing from 30 to 60 wt. % of one or more C₁-C₁₀ alcohols together with a polymeric enhancer. The hydroalcoholic disinfecting compositions have a pH of less than 3. The hydroalcoholic disinfecting compositions achieve broad efficacy against harmful microorganisms, including pathogenic microorganisms.

### BACKGROUND

Disinfecting compositions have become increasingly popular with the general public not only for cleaning, but also for disinfecting surfaces in the home or workplace. It is particularly desirable to disinfect hard surfaces in healthcare applications, without the need for further rinsing or cleansing. Such disinfection may be achieved via compositions in the form of wipes, disinfecting sprays, or bulk disinfectants. Regardless of form, multi-surface compositions are desirable for rapid efficacy against bacteria, viruses, and fungi.

In response to these demands, current consumer products often comprise a combination of alcohol and one or more quaternary ammonium compounds to achieve the desired efficacy for hard surface disinfection. However, in response to changing perceptions of quaternary ammonium compounds with respect to both potential toxicity and surface residue of products comprising the ingredients, it has become desirable to formulate a hard surface disinfecting composition without the use of quaternary ammonium compounds.

As such, a need exists for a method of decontaminating surfaces, particularly hard surfaces, which provides an enhanced antimicrobial efficacy against harmful microorganisms and a reduced residue profile, in the absence of quaternary ammonium ingredients.

### SUMMARY

The general inventive concepts are directed to disinfecting compositions comprising from 30 to 60 wt. % of one or more C₁-C₁₀ alcohols, one or more polymeric enhancers, and one or more secondary enhancers, wherein the disinfecting compositions have a pH of less than 3. Methods for disinfecting a surface, and methods for the inactivation of bacterial or fungal spores, are also disclosed. Wipe substrates comprising a disinfecting composition are also disclosed. In embodiments of the present disclosure, the one or more polymeric enhancers comprises an alkoxylated polyol ester. One exemplary alkoxylated polyol ester is assigned CAS number 1685270-84-1.

### DETAILED DESCRIPTION

Disclosed herein are hydroalcoholic disinfecting compositions. While the present disclosure describes certain embodiments of the hydroalcoholic disinfecting compositions in detail, the present disclosure is to be considered exemplary and is not intended to be limited to the disclosed embodiments.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Furthermore, when the phrase “one or more of A and B” is employed it is intended to mean “only A, only B, or both A and B.” Similarly, when the phrase “at least one of A, B, and C” is employed it is intended to mean “only A, only B, only C, or any combination of A, B, and C” (e.g., A and B; B and C; A and C; A, B, and C).

The hydroalcoholic disinfecting compositions of the present disclosure can comprise, consist of, or consist essentially of the essential elements of the disclosure as described herein, as well as any additional or optional element described herein, or which is otherwise useful in disinfecting applications.

All percentages, parts, and ratios as used herein are by weight of the total formulation, unless otherwise specified.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

The general inventive concepts relate to hydroalcoholic disinfecting compositions. More particularly, the inventive concepts relate to hydroalcoholic disinfecting compositions comprising from 30 to 60 wt. % of one or more C₁-C₁₀ alcohols together with a polymeric enhancer. The hydroalcoholic disinfecting compositions have a pH of less than 3, and achieve an enhanced efficacy against pathogenic microorganisms.

In accordance with the present disclosure, the hydroalcoholic disinfecting compositions comprise one or more alcohols. The term “alcohol,” as used herein, constitutes any compound containing at least one carbon bonded to at least one hydroxyl group, i.e., any molecule having the structure R₁R₂R₃C—OH, including linear or branched compounds. The identity of the “R” groups, i.e., R₁ R₂ and R₃ groups, are not particularly limited.

In accordance with the present disclosure, the hydroalcoholic disinfecting compositions comprise one or more C₁-C₁₀ alcohols, i.e., alcohols containing 1 to 10 carbon atoms. In accordance with the present disclosure, the hydroalcoholic disinfecting compositions comprise one or more C₁-C₈ alcohols. In accordance with the present disclosure, the hydroalcoholic disinfecting compositions comprise one or more C₁-C₆ alcohols. Such C₁-C₆ alcohols may be referred to as lower alkanols, and are distinct from long-chain alcohols (i.e., fatty alcohols). Examples of lower alkanols include, but are not limited to, methanol, ethanol, propanol, butanol, pentanol, hexanol, and isomers and mixtures thereof. In some embodiments, the one or more alcohols comprise ethanol, propanol, or butanol, or isomers or mixtures thereof. In some embodiments, the one or more alcohols comprise, or consist of, isopropanol. In some embodiments, the one or more alcohols comprise, or consist of, ethanol. In some embodiments, the compositions comprise a mixture of alcohols. In some embodiments, the compositions comprise, or consist of, a mixture of ethanol and isopropanol.

In accordance with the present disclosure, the hydroalcoholic disinfecting compositions comprise from 30 to 60 weight percent (wt. %) of one or more C₁-C₁₀ alcohols, based upon the total weight of the composition. In some embodiments, the hydroalcoholic disinfecting compositions comprise from greater than 30 to less than 60 wt. % of one or more C₁-C₁₀ alcohols, based upon the total weight of the composition. In some embodiments, the hydroalcoholic disinfecting compositions comprise from 35 to 60 wt. % of one or more C₁-C₁₀ alcohols, based upon the total weight of the composition. In some embodiments, the hydroalcoholic disinfecting compositions comprise from 40 to 60 wt. % of one or more C₁-C₁₀ alcohols, based upon the total weight of the composition. In some embodiments, the hydroalcoholic disinfecting compositions comprise from greater than 40 to less than 60 wt. % of one or more C₁-C₁₀ alcohols, based upon the total weight of the composition. In some embodiments, the hydroalcoholic disinfecting compositions comprise from 50 to 60 wt. % of one or more C₁-C₁₀ alcohols, based upon the total weight of the composition. In some embodiments, the hydroalcoholic disinfecting compositions comprise from greater than 50 to less than 60 wt. % of one or more C₁-C₁₀ alcohols, based upon the total weight of the composition. In some embodiments, the hydroalcoholic disinfecting compositions comprise from 55 to 60 wt. % of one or more C₁-C₁₀ alcohols, based upon the total weight of the composition. In some embodiments, the hydroalcoholic disinfecting compositions comprise from greater than 55 to less than 60 wt. % of one or more C₁-C₁₀ alcohols, based upon the total weight of the composition.

In accordance with the present disclosure, the hydroalcoholic disinfecting compositions comprise one or more polymeric enhancers. In some embodiments, the one or more polymeric enhancers comprise, or consist of, an ester, such as a polyol ester. In some embodiments, the one or more polymeric enhancers comprise, or consist of, an alkoxylated polyol ester. One exemplary alkoxylated polyol ester is assigned CAS number 1685270-84-1, currently available as Atplus™ UEP-100 manufactured by Croda International Plc (Snaith, England). According to publicly available information, the alkoxylated polyol ester assigned CAS number 1685270-84-1 comprises fatty acids, C18-unsatd., dimers, polymers with docosanoic acid, 1,3-propanediol, and stearic acid, and has a minimum number average molecular weight (in amu) of 1,100. It has been surprisingly found that the alkoxylated polyol ester assigned CAS number 1685270-84-1 acts as an efficacy enhancer in hydroalcoholic disinfecting compositions for surfaces, as the ingredient was previously only known as an adjuvant suitable for use as a leaf-penetrating agent in agrochemical applications.

In accordance with the present disclosure, the hydroalcoholic disinfecting compositions comprise up to 10 wt. % of the one or more polymeric enhancers, based upon the total weight of the composition. In some embodiments, the hydroalcoholic disinfecting compositions comprise up to 5 wt. % of the one or more polymeric enhancers, based upon the total weight of the composition. In some embodiments, the hydroalcoholic disinfecting compositions comprise up to 3 wt. % of the one or more polymeric enhancers, based upon the total weight of the composition. In some embodiments, the hydroalcoholic disinfecting compositions comprise up to 2 wt. % of the one or more polymeric enhancers, based upon the total weight of the composition. In some embodiments, the hydroalcoholic disinfecting compositions comprise from 0.005 to 10 wt. % of the one or more polymeric enhancers, based upon the total weight of the composition. In some embodiments, the hydroalcoholic disinfecting compositions comprise from 0.01 to 5 wt. % of the one or more polymeric enhancers, based upon the total weight of the composition. In some embodiments, the hydroalcoholic disinfecting compositions comprise from 0.1 to 3 wt. % of the one or more polymeric enhancers, based upon the total weight of the composition. In some embodiments, the hydroalcoholic disinfecting compositions comprise from 0.1 to 2 wt. % of the one or more polymeric enhancers, based upon the total weight of the composition. In some embodiments, the hydroalcoholic disinfecting compositions comprise from 0.2 to 1 wt. % of the one or more polymeric enhancers, based upon the total weight of the composition.

In any of the embodiments disclosed herein, the one or more polymeric enhancers may comprise, or consist of, an alkoxylated polyol ester, such as the alkoxylated polyol ester assigned CAS number 1685270-84-1. In accordance with the present disclosure, the hydroalcoholic disinfecting compositions comprise up to 10 wt. % of the alkoxylated polyol ester, based upon the total weight of the composition. In some embodiments, the hydroalcoholic disinfecting compositions comprise up to 5 wt. % of the alkoxylated polyol ester, based upon the total weight of the composition. In some embodiments, the hydroalcoholic disinfecting compositions comprise up to 3 wt. % of the alkoxylated polyol ester, based upon the total weight of the composition. In some embodiments, the hydroalcoholic disinfecting compositions comprise up to 2 wt. % of the alkoxylated polyol ester, based upon the total weight of the composition. In some embodiments, the hydroalcoholic disinfecting compositions comprise from 0.005 to 10 wt. % of the alkoxylated polyol ester, based upon the total weight of the composition. In some embodiments, the hydroalcoholic disinfecting compositions comprise from 0.01 to 5 wt. % of the alkoxylated polyol ester, based upon the total weight of the composition. In some embodiments, the hydroalcoholic disinfecting compositions comprise from 0.1 to 3 wt. % of the alkoxylated polyol ester, based upon the total weight of the composition. In some embodiments, the hydroalcoholic disinfecting compositions comprise from 0.1 to 2 wt. % of the alkoxylated polyol ester, based upon the total weight of the composition. In some embodiments, the hydroalcoholic disinfecting compositions comprise from 0.2 to 1 wt. % of the alkoxylated polyol ester, based upon the total weight of the composition.

In accordance with the present disclosure, the hydroalcoholic disinfecting compositions may comprise one or more secondary enhancers, that is, one or more enhancers in addition to the one or more polymeric enhancers. In some embodiments, it has been found that one or more secondary enhancers further enhance the efficacy of the hydroalcoholic disinfecting compositions comprising one or more C₁-C₁₀ alcohols and one or more polymeric enhancers. Surprisingly, it has been found that the secondary enhancers do not significantly enhance the efficacy of the alcohol unless the primary polymeric enhancer is also present. Exemplary secondary enhancers include, but are not limited to, glycols, such as ethylene glycols, propylene glycols, butylene glycols, hexylene glycols, caprylyl glycol, or combinations thereof. In some embodiments, the one or more secondary enhancers comprise, or consists of, glycols. In some embodiments, the one or more secondary enhancers comprise, or consists of, hexylene glycol, caprylyl glycol, dipropylene glycol, or combinations thereof.

In accordance with the present disclosure, the hydroalcoholic disinfecting compositions comprise up to 15 wt. % of the one or more secondary enhancers, based upon the total weight of the composition. In some embodiments, the hydroalcoholic disinfecting compositions comprise up to 10 wt. % of the one or more secondary enhancers, based upon the total weight of the composition. In some embodiments, the hydroalcoholic disinfecting compositions comprise up to 5 wt. % of the one or more secondary enhancers, based upon the total weight of the composition. In some embodiments, the hydroalcoholic disinfecting compositions comprise up to 3 wt. % of the one or more secondary enhancers, based upon the total weight of the composition. In some embodiments, the hydroalcoholic disinfecting compositions comprise from 0.005 to 15 wt. % of the one or more secondary enhancers, based upon the total weight of the composition. In some embodiments, the hydroalcoholic disinfecting compositions comprise from 0.01 to 10 wt. % of the one or more secondary enhancers, based upon the total weight of the composition. In some embodiments, the hydroalcoholic disinfecting compositions comprise from 0.1 to 5 wt. % of the one or more secondary enhancers, based upon the total weight of the composition. In some embodiments, the hydroalcoholic disinfecting compositions comprise from 0.5 to 3.5 wt. % of the one or more secondary enhancers, based upon the total weight of the composition. In some embodiments, the hydroalcoholic disinfecting compositions comprise from 1 to 3.5 wt. % of the one or more secondary enhancers, based upon the total weight of the composition. In some embodiments, the hydroalcoholic disinfecting compositions comprise from 1.5 to 3.5 wt. % of the one or more secondary enhancers, based upon the total weight of the composition.

In any of the embodiments disclosed herein, the one or more secondary enhancers may comprise, or consist of, hexylene glycol. In accordance with the present disclosure, the hydroalcoholic disinfecting compositions comprise up to 15 wt. % of hexylene glycol, based upon the total weight of the composition. In some embodiments, the hydroalcoholic disinfecting compositions comprise up to 10 wt. % of hexylene glycol, based upon the total weight of the composition. In some embodiments, the hydroalcoholic disinfecting compositions comprise up to 5 wt. % of hexylene glycol, based upon the total weight of the composition. In some embodiments, the hydroalcoholic disinfecting compositions comprise up to 3 wt. % of hexylene glycol, based upon the total weight of the composition. In some embodiments, the hydroalcoholic disinfecting compositions comprise from 0.005 to 15 wt. % of hexylene glycol, based upon the total weight of the composition. In some embodiments, the hydroalcoholic disinfecting compositions comprise from 0.01 to 10 wt. % of hexylene glycol, based upon the total weight of the composition. In some embodiments, the hydroalcoholic disinfecting compositions comprise from 0.1 to 5 wt. % of hexylene glycol, based upon the total weight of the composition. In some embodiments, the hydroalcoholic disinfecting compositions comprise from 0.5 to 3.5 wt. % of hexylene glycol, based upon the total weight of the composition. In some embodiments, the hydroalcoholic disinfecting compositions comprise from 1 to 3.5 wt. % of hexylene glycol, based upon the total weight of the composition. In some embodiments, the hydroalcoholic disinfecting compositions comprise from 1.5 to 3.5 wt. % of hexylene glycol, based upon the total weight of the composition.

In accordance with the present disclosure, the hydroalcoholic disinfecting compositions may comprise one or more surfactants. In some embodiments, the one or more surfactants comprise anionic, cationic, zwitterionic, or nonionic surfactants. The term “amphoteric” surfactant is often used interchangeably with the term “zwitterionic” surfactant, i.e., each term has the identical meaning of surfactants having both cationic and anionic centers attached to the same molecule. In some embodiments, the one or more surfactants are selected from the group consisting of cationic, zwitterionic, or nonionic surfactants. In some embodiments, the hydroalcoholic disinfecting compositions are devoid of anionic surfactants. In some embodiments, the hydroalcoholic disinfecting compositions are devoid of amphoteric and zwitterionic surfactants. In some embodiments, the hydroalcoholic disinfecting compositions are devoid of cationic surfactants.

In accordance with the present disclosure, the one or more surfactants comprise, or consist of, one or more nonionic surfactants. In some embodiments, the one or more nonionic surfactants comprise, or consist of, one or more alkyl polyglucosides. The class of alkyl polyglucosides (“APG”) are derived from a glucose sugar and a fatty alcohol, including in which the alkyl group contains 8-18 carbon atoms, glycerol fatty acid esters, polyoxyethylene glycerol fatty acid esters, polyoxyethylene sorbitan fatty acid esters, polyethylene glycol fatty acid esters and polyoxyethylene polyoxypropylene block copolymers with terminal hydroxyl groups and combinations thereof.

In accordance with the present disclosure, the hydroalcoholic disinfecting compositions comprise up to 10 wt. % of one or more surfactants, based upon the total weight of the composition. In some embodiments, the hydroalcoholic disinfecting compositions comprise up to 5 wt. % of one or more surfactants, based upon the total weight of the composition. In some embodiments, the hydroalcoholic disinfecting compositions comprise up to 1 wt. % of one or more surfactants, based upon the total weight of the composition. In some embodiments, the hydroalcoholic disinfecting compositions comprise from 0.01 to 10 wt. % of one or more surfactants, based upon the total weight of the composition. In some embodiments, the hydroalcoholic disinfecting compositions comprise from 0.05 to 5 wt. % of one or more surfactants, based upon the total weight of the composition. In some embodiments, the hydroalcoholic disinfecting compositions comprise from 0.05 to 2 wt. % of one or more surfactants, based upon the total weight of the composition. In some embodiments, the hydroalcoholic disinfecting compositions comprise from 0.1 to 2 wt. % of one or more surfactants, based upon the total weight of the composition. In some embodiments, the hydroalcoholic disinfecting compositions comprise from 0.1 to 1 wt. % of one or more surfactants, based upon the total weight of the composition.

In accordance with the present disclosure, the hydroalcoholic disinfecting compositions have a pH of less than 3. In accordance with the present disclosure, the hydroalcoholic disinfecting compositions may have a pH of 2.75 or less. In accordance with the present disclosure, the hydroalcoholic disinfecting compositions may have a pH of 2.5 or less. In accordance with the present disclosure, the hydroalcoholic disinfecting compositions may have a pH of 2 or less. In accordance with the present disclosure, the hydroalcoholic disinfecting compositions may have a pH of 1.75 or less. In accordance with the present disclosure, the hydroalcoholic disinfecting compositions may have a pH of 1.5 or less. In any of the embodiments disclosed herein, the hydroalcoholic disinfecting compositions may have a pH of from 1 to less than 3. In some embodiments, the hydroalcoholic disinfecting compositions may have a pH of from greater than 1 to less than 3. In some embodiments, the hydroalcoholic disinfecting compositions may have a pH of from greater than 1 to less than 2.75. In some embodiments, the hydroalcoholic disinfecting compositions may have a pH of from greater than 1 to less than 2.5. In some embodiments, the hydroalcoholic disinfecting compositions may have a pH of from greater than 1 to less than 2. The hydroalcoholic disinfecting compositions may therefore be referred to as acidified, since the compositions have an acidic pH. In accordance with the present disclosure, the pH value obtained is a potentiometric pH, and the actual proton activity may vary.

In accordance with the present disclosure, the hydroalcoholic disinfecting compositions may be acidified by the addition of one or more pH adjusting agents. In some embodiments, the one or more pH adjusting agents comprise an organic acid. In some embodiments, the one or more pH adjusting agents may comprise organic acids such as acetic acid, adipic acid, benzene 1,3,5 tricarboxylic acid, butyric acid, chlorosuccinic acid, choline chloride, cis-aconitic acid, citramalic acid, citric acid, cyclobutane 1,1,3,3 tetracarboxylic acid, cyclohexane 1,2,4,5 tetracarboxylic acid, cyclopentane 1,2,3,4 tetracarboxylic acid, diglycolic acid, formic acid, fumaric acid, glutamic acid, glutaric acid, glyoxylic acid, isocitric acid, ketomalonic acid, lactic acid, maleic acid, malic acid, malonic acid, nitrilotriacetic acid, oxalacetic acid, oxalic acid, propionic acid, phytic acid, p-toluenesulfonic acid, salicylic acid, succinic acid, tartaric acid, tartronic acid, tetrahydrofuran 2,3,4,5 tetracarboxylic acid, tricarballylic acid, versene acids, 3-hydroxyglutaric acid, 2-hydroxypropane 1,3 dicarboxylic acid, glyceric acid, furan 2,5 dicarboxylic acid, 3,4-dihydroxyfuran-2,5 dicarboxylic acid, 3,4-dihydroxytetrahydrofuran-2,5-dicarboxylic acid, 2-oxo-glutaric acid, dl-glyceric acid, 2,5 furandicarboxylic acid, or combinations thereof. In some embodiments, the one or more pH adjusting agents comprise inorganic acids such as hydrochloric acid, nitric acid, sulfuric acid, phosphonic acid, phosphoric acid, boric acid, or combinations thereof. In any of the embodiments disclosed herein, the one or more pH adjusting agents may comprise, or consist of, hydrochloric acid, phosphoric acid, sulfuric acid, or combinations thereof. It has been surprisingly found that certain acids enhance the antimicrobial efficacy of the hydroalcoholic disinfecting composition, beyond the conventional effect of simply adjusting the pH of the composition.

In accordance with the present disclosure, the hydroalcoholic disinfecting compositions comprise up to 5 wt. % of one or more pH adjusting agents, based upon the total weight of the composition. In some embodiments, the hydroalcoholic disinfecting compositions comprise up to 3 wt. % of one or more pH adjusting agents, based upon the total weight of the composition. In some embodiments, the hydroalcoholic disinfecting compositions comprise up to 1 wt. % of one or more pH adjusting agents, based upon the total weight of the composition. In some embodiments, the hydroalcoholic disinfecting compositions comprise from 0.01 to 5 wt. % of one or more pH adjusting agents, based upon the total weight of the composition. In some embodiments, the hydroalcoholic disinfecting compositions comprise from 0.01 to 2 wt. % of one or more pH adjusting agents, based upon the total weight of the composition. In some embodiments, the hydroalcoholic disinfecting compositions comprise from 0.1 to 1 wt. % of one or more pH adjusting agents, based upon the total weight of the composition.

In accordance with the present disclosure, the hydroalcoholic disinfecting compositions comprise water quantum sufficit (q.s.). In some embodiments, the hydroalcoholic disinfecting compositions comprise up to 70 wt. % water. In some embodiments, the hydroalcoholic disinfecting compositions comprise up to 60 wt. % water. In some embodiments, the hydroalcoholic disinfecting compositions comprise up to 50 wt. % water. In some embodiments, the hydroalcoholic disinfecting compositions comprise up to 40 wt. % water. In some embodiments, the hydroalcoholic disinfecting compositions comprise up to 30 wt. % water. More or less water may be required in certain instances, depending particularly on other ingredients and/or the amounts thereof employed.

In accordance with the present disclosure, the hydroalcoholic disinfecting compositions may be devoid of quaternary compounds. Quaternary compounds are compounds that include a positively charged polyatomic ion of the structure NR⁴⁺, with R being an alkyl group or an aryl group. Unlike the ammonium ion (NH⁴⁺) and the primary, secondary, or tertiary ammonium cations, the quaternary ammonium cations are permanently charged, independent of the pH of their solution. Examples of excluded quaternary compounds include, but are not limited to, benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, and domiphen bromide.

It has been surprisingly found that the use of the one or more polymeric enhancers increases the efficacy of the hydroalcoholic disinfecting composition by a statistically significant amount, compared to an otherwise identical composition without the polymeric enhancer. Specifically, without being bound to theory, the inventors have surprisingly discovered that an alkoxylated polyol ester such as the alkoxylated polyol ester assigned CAS number 1685270-84-1 improves the interaction between the alcohol and the coating of a pathogenic microorganism, in that the alkoxylated polyol ester improves the penetration of the alcohol into the bacterial spore. It has been found that the alkoxylated polyol ester assigned CAS number 1685270-84-1 exhibits little or no efficacy as an active ingredient on its own; however, when combined with the C₁-C₁₀ alcohol at a low pH, the resultant combination shows an enhanced efficacy compared to the C₁-C₁₀ alcohol on its own, i.e., in the absence of the enhancer. Thus, the combination of C₁-C₁₀ alcohol and the alkoxylated polyol ester assigned CAS number 1685270-84-1has a synergistic effect, i.e., more than just an additive effect, on the efficacy of the inventive formulation against bacteria.

The hydroalcoholic disinfecting compositions achieve a broad-spectrum efficacy, including efficacy against Gram negative and Gram positive bacteria, fungi, yeast, mold, and pathogenic microorganisms. Unless otherwise specified, the term “efficacy” includes killing, reducing, neutralizing, or deactivating spores, or any combination of the foregoing. In accordance with the present disclosure, the hydroalcoholic disinfecting compositions may achieve efficacy against bacteria such as Staphylococcus aureus, methicillin-resistant S. aureus, Escherichia coli, Pseudomonas aeruginosa, Serratia marcescens, yeast such as Candida albicans, mold such as Aspergillus niger, fungi such as Trichophyton mentagrophytes, and enveloped viruses including Influenza A virus. In one or more embodiments, the hydroalcoholic disinfecting compositions may also achieve efficacy against bacterial spores such as Clostridium difficile and Bacillus anthracis.

Unless otherwise specified, the term “log reduction” as used herein refers to log 10 reduction. In accordance with the present disclosure, the hydroalcoholic disinfecting compositions provide a log reduction against bacterial spores of at least 4 log in less than 1 minute. To achieve this reduction, the amount of hydroalcoholic disinfecting composition to be applied to the target surface is not particularly limited. At a minimum, a sufficient amount of hydroalcoholic disinfecting composition should be applied to substantially wet the surface such that the surface will remain wet for the desired contact time, noting that there will be some evaporation of the hydroalcoholic disinfecting composition.

The hydroalcoholic disinfecting compositions of the present invention can further comprise a wide range of optional additives, with the proviso that they do not deleteriously affect the compositions' ability to disinfect surfaces. Notably, the hydroalcoholic disinfecting compositions of the present invention may be devoid of auxiliary antimicrobial agents or preservatives. Any antimicrobial ingredient other than the combination of alcohol and polymeric enhancer may be referred to as an auxiliary antimicrobial agent.

In accordance with the present disclosure, the hydroalcoholic disinfecting compositions of the present invention may be formulated as liquids. For example, the hydroalcoholic disinfecting compositions may be formulated as liquids that are poured, pumped, sprayed, dipped, rolled, or otherwise dispensed, including liquid concentrates and dilutable liquids. Some or all embodiments of the present disclosure include the hydroalcoholic disinfecting compositions delivered in or on a wipe, i.e. a tissue or cloth that is impregnated with a liquid and wiped over a surface. In particular, the hydroalcoholic disinfecting compositions of the present invention may be utilized in a premoistened wipe. The premoistened wipe may comprise the composition and a substrate, with the wipe substrate selected to hold the hydroalcoholic disinfecting composition during preparation and storage, and also readily express the liquid composition during use.

The hydroalcoholic disinfecting compositions of the present invention may be employed on a wide variety of surfaces or substrates, including hard surfaces, soft surfaces, non-living (inanimate) surfaces, living tissue, skin, soil, porous, and non-porous surfaces. In the present disclosure, it is understood that the term “surface” includes skin. Embodiments of the present disclosure may be employed to disinfect or otherwise sanitize inanimate objects such as instruments, medical equipment, furniture, handrails, textiles, etc.

The below table shows exemplary hydroalcoholic disinfecting compositions. In any of the embodiments disclosed herein, the hydroalcoholic disinfecting compositions may comprise or consist of formulations according to the following percentages by weight of the composition:

TABLE 1

| Ingredient Class | Exemplary Ingredients | Particular Embodiment | Range |
|---|---|---|---|
| One or more C₁-C₁₀ | One or more C₁-C₆ | Isopropanol | 30 to 60 wt. % |
| alcohols | alcohols | | |
| One or more | One or more polyol esters | The alkoxylated polyol | 0.005 to 10 wt. % |
| polymeric enhancers | | ester assigned CAS number | |
| | | 1685270-84-1 | |
| One or more | One or more glycols | Hexylene glycol, caprylyl | 0.005 to 15 wt. % |
| secondary enhancers | | glycol, or combinations | |
| | | thereof | |
| One or more | One or more nonionic | One or more alkyl | 0.01 to 10 wt. % |
| surfactants | surfactants | polyglucosides | |
| One or more pH | One or more organic or | Hydrochloric acid, | 0.01 to 5 wt. % |
| adjusting agents | inorganic acids | phosphoric acid, sulfuric | |
| | | acid, or combinations | |
| | | thereof | |
| Water | | | Up to 70 wt. % |
| pH | | | Less than 3 |

The following paragraphs provide further non-limiting exemplary embodiments.
Paragraph 1. A disinfecting composition comprising: from 30 to 60 wt. % of one or more C₁-C₁₀ alcohols; one or more polymeric enhancers; and one or more secondary enhancers, wherein the disinfecting composition has a pH of less than 3.
Paragraph 2. The disinfecting composition of paragraph 1, wherein the disinfecting composition comprises from 40 to 60 wt. % of the one or more C₁-C₁₀ alcohols.
Paragraph 3. The disinfecting composition of any of the preceding paragraphs, wherein the disinfecting composition comprises from 50 to 60 wt. % of the one or more C₁-C₁₀ alcohols.
Paragraph 4. The disinfecting composition of any of the preceding paragraphs, wherein the one or more C₁-C₁₀ alcohols comprise one or more C₁-C₆ alcohols.
Paragraph 5. The disinfecting composition of any of the preceding paragraphs, wherein the one or more C₁-C₁₀ alcohols comprise isopropanol, ethanol, or mixtures thereof.
Paragraph 6. The disinfecting composition of any of the preceding paragraphs, wherein the disinfecting composition comprises from 0.1 to 3 wt. % of the one or more polymeric enhancers.
Paragraph 7. The disinfecting composition of any of the preceding paragraphs, wherein the disinfecting composition comprises from 0.2 to 1 wt. % of the one or more polymeric enhancers.
Paragraph 8. The disinfecting composition of any of the preceding paragraphs, wherein the one or more polymeric enhancers comprises an alkoxylated polyol ester.
Paragraph 9. The disinfecting composition of any of the preceding paragraphs, wherein the disinfecting composition comprises from 0.01 to 10 wt. % of the one or more secondary enhancers.
Paragraph 10. The disinfecting composition of any of the preceding paragraphs, wherein the disinfecting composition comprises from 0.1 to 5 wt. % of the one or more secondary enhancers.
Paragraph 11. The disinfecting composition of any of the preceding paragraphs, wherein the one or more secondary enhancers comprise hexylene glycol, caprylyl glycol, or combinations thereof.
Paragraph 12. The disinfecting composition of any of the preceding paragraphs, wherein the disinfecting composition further comprises one or more nonionic surfactants.
Paragraph 13. The disinfecting composition of any of the preceding paragraphs, wherein the disinfecting composition further comprises one or more pH adjusting agents.
Paragraph 14. The disinfecting composition of any of the preceding paragraphs, wherein the disinfecting composition further comprises water.
Paragraph 15. The disinfecting composition of any of the preceding paragraphs, wherein the disinfecting composition has a pH of 2.75 or less.
Paragraph 16. The disinfecting composition of any of the preceding paragraphs, wherein the disinfecting composition has a pH of 2.5 or less.
Paragraph 17. The disinfecting composition of any of the preceding paragraphs, wherein the disinfecting composition has a pH of 2 or less.
Paragraph 18. A method for the disinfection of a surface, the method comprising: contacting the surface with the disinfecting composition of any of the preceding paragraphs.
Paragraph 19. A method for the inactivation of bacterial or fungal spores, the method comprising: contacting the spores with the disinfecting composition of any of paragraphs 1-17.
Paragraph 20. A wipe substrate comprising the disinfecting composition of any of paragraphs 1-17.

The general inventive concepts have been described above both generally and with regard to various specific exemplary embodiments. Although the general inventive concepts have been set forth in what are believed to be exemplary illustrative embodiments, a wide variety of alternatives will be apparent to those of skill in the art from reading this disclosure. The general inventive concepts are not otherwise limited, except for those instances when presented in specific claims.

### EXAMPLES

The following examples are included for the purposes of illustration, and do not limit the scope of the general inventive concepts described herein.

### Example 1

The efficacy of various hydroalcoholic disinfecting compositions against Staphylococcus aureus spores was observed, according to the EPA “Standard Operating Procedure for OECD Quantitative Method for Evaluating Bactericidal and Mycobactericidal Activity of Microbicides Used on Hard, Non-Porous Surfaces” (SOP Number: MB-25-05) (Date Revised: Apr. 16, 2019). Seven formulations were prepared, comprising two inventive formulations and five comparative formulations. Each of the seven formulations were adjusted to a pH of 2.5.

Test cultures of Staphylococcus aureus (S. aureus) ATCC 6538 were used to test each compositions' efficacy, with a 1 cm stainless steel disc serving as the test surface. 50 microliters of test substance was applied to each carrier, with a contact time of 10 seconds.

The purpose of the experiment was to evaluate the efficacy of a hydroalcoholic disinfecting composition comprising the alkoxylated polyol ester assigned CAS number 1685270-84-1. Accordingly, control formulations were tested as noted in Table 2, including 30% and 50% isopropanol (“IPA”) controls, respectively, as well as a 1% alkoxylated polyol ester control. The alkoxylated polyol ester used in each of the samples was CAS number 1685270-84-1, currently available as Atplus™ UEP-100 manufactured by Croda International Plc (Snaith, England). The four samples denoted “BSW” comprised a surfactant to provide commercially acceptable hydroalcoholic composition at the noted concentration of alcohol. Thus, Samples 3 and 5 of Table 2 (i.e., 30% alcohol formulations) were otherwise identical but for the addition of 1% alkoxylated polyol ester, and Samples 4 and 6 of Table 2 (i.e., 50% alcohol formulations) were otherwise identical but for the addition of 1% alkoxylated polyol ester.

The efficacy against S. aureus spores for each of the seven samples at 10 seconds contact time is shown in Table 2.

TABLE 2
S. aureus Micro-Efficacy with a 10-Second Contact Time

| | | | | | Average |
|---|---|---|---|---|---|
| | | Isopropanol | UEP | | Log |
| | Description | (wt. %) | (wt. %) | pH | Reduction |
| 1 | 30% IPA Control | 30% | None | 2.5 | 2.01 |
| 2 | 50% IPA Control | 50% | None | 2.5 | 1.79 |
| 3 | 30% IPA BSW w/o UEP | 30% | None | 2.5 | 2.63 |
| 4 | 50% IPA BSW w/o UEP | 50% | None | 2.5 | 2.64 |
| 5 | 30% IPA BSW w/1% UEP | 30% | 1% | 2.5 | 3.06 |
| 6 | 50% IPA BSW w/1% UEP | 50% | 1% | 2.5 | 3.24 |
| 7 | 1% UEP | None | 1% | 2.5 | 0.20 |

As shown in Table 2, only Samples 5 and 6 in accordance with the instant disclosure met the success criteria (i.e., at least a 3-log average reduction in S. aureus within 10 seconds).

### Example 2

The efficacy of particular 60% alcohol disinfecting compositions against Staphylococcus aureus spores was observed, according to the ASTM E 2315-16 method, “Standard Guide for Assessment of Antimicrobial Activity Using a Time-Kill Procedure” (last updated May 1, 2023). The purpose of this standardized test method is to assess the in vitro reduction of a microbial population of test organisms after exposure to a test material. Eight formulations were prepared, comprising two inventive formulations and six comparative formulations. Each of the eight formulations were adjusted to a pH of 2.5.

Test cultures of Staphylococcus aureus (S. aureus) ATCC 6538 and Pseudomonas aeruginosa (P. aeruginosa) ATCC 15442 were used to test each compositions' efficacy, with a 1 cm stainless steel disc serving as the test surface. 50 microliters of test substance was applied to each carrier, with a contact time of 30 seconds.

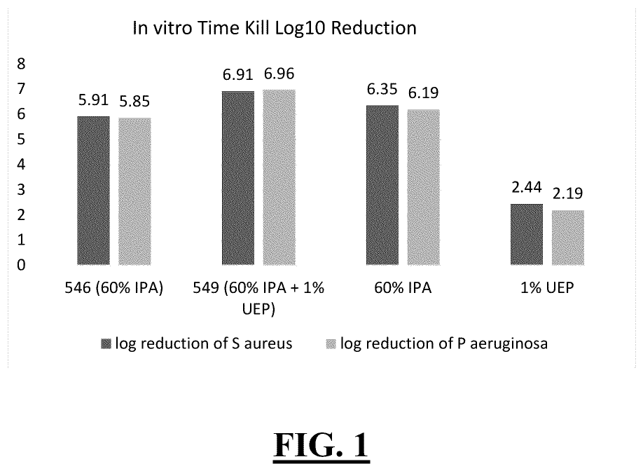

The purpose of the experiment was to evaluate the in vitro efficacy of the inventive hydroalcoholic disinfecting composition comprising the alkoxylated polyol ester assigned CAS number 1685270-84-1 in a 60% alcohol formulation. Accordingly, control formulations were tested as noted in FIG. 1, including a 60% isopropanol control (“60% IPA”) and a 1% alkoxylated polyol ester control (“1% UEP”). The alkoxylated polyol ester used in each of the samples was CAS number 1685270-84-1, currently available as Atplus™ UEP-100 manufactured by Croda International Plc (Snaith, England). The samples denoted “546 (60% IPA)” and “549 (60% IPA+1% UEP)” comprised a surfactant to provide commercially acceptable hydroalcoholic composition at the noted 60% concentration of alcohol. Thus, Samples 546 and 549 were otherwise identical but for the inclusion of 1% alkoxylated polyol ester in Sample 549.

The efficacy against S. aureus and P. aeruginosa spores, respectively, for each of the eight samples at 30 seconds contact time is shown in FIG. 1.

As shown in FIG. 1, the addition of 1% UEP to the formulation (i.e., the comparison of Sample 549 to Sample 546) results in greater than a 1 log increased reduction of gram positive and gram negative organisms.

What is claimed is:

1. A disinfecting composition comprising:
from 30 to 60 wt. % of one or more C₁-C₁₀ alcohols;
one or more polymeric enhancers; and
one or more secondary enhancers,
wherein the disinfecting composition has a pH of less than 3.

2. The disinfecting composition of claim 1, wherein the disinfecting composition comprises from 40 to 60 wt. % of the one or more C₁-C₁₀ alcohols.

3. The disinfecting composition of claim 1, wherein the disinfecting composition comprises from 50 to 60 wt. % of the one or more C₁-C₁₀ alcohols.

4. The disinfecting composition of claim 1, wherein the one or more C₁-C₁₀ alcohols comprise one or more C₁-C₆ alcohols.

5. The disinfecting composition of claim 1, wherein the one or more C₁-C₁₀ alcohols comprise isopropanol, ethanol, or mixtures thereof.

6. The disinfecting composition of claim 1, wherein the disinfecting composition comprises from 0.1 to 3 wt. % of the one or more polymeric enhancers.

7. The disinfecting composition of claim 1, wherein the disinfecting composition comprises from 0.2 to 1 wt. % of the one or more polymeric enhancers.

8. The disinfecting composition of claim 1, wherein the one or more polymeric enhancers comprises an alkoxylated polyol ester.

9. The disinfecting composition of claim 1, wherein the disinfecting composition comprises from 0.01 to 10 wt. % of the one or more secondary enhancers.

10. The disinfecting composition of claim 1, wherein the disinfecting composition comprises from 0.1 to 5 wt. % of the one or more secondary enhancers.

11. The disinfecting composition of claim 1, wherein the one or more secondary enhancers comprise hexylene glycol, caprylyl glycol, or combinations thereof.

12. The disinfecting composition of claim 1, wherein the disinfecting composition further comprises one or more nonionic surfactants.

13. The disinfecting composition of claim 1, wherein the disinfecting composition further comprises one or more pH adjusting agents.

14. The disinfecting composition of claim 1, wherein the disinfecting composition further comprises water.

15. The disinfecting composition of claim 1, wherein the disinfecting composition has a pH of 2.75 or less.

16. The disinfecting composition of claim 1, wherein the disinfecting composition has a pH of 2.5 or less.

17. The disinfecting composition of claim 1, wherein the disinfecting composition has a pH of 2 or less.

18. A method for the disinfection of a surface, the method comprising:
contacting the surface with the disinfecting composition of claim 1.

19. A method for the inactivation of bacterial or fungal spores, the method comprising:
contacting the spores with the disinfecting composition of claim 1.

20. A wipe substrate comprising the disinfecting composition of claim 1.
